(19) United States
(12) Patent Application Publication
(10) Pub. No.: US 2013/0117144 A1
(43) Pub. Date: May 9, 2013

(54) TRANSACTING A SALE

(71) Applicant: Danny Wu, Studio City, CA (US)

(72) Inventor: Danny Wu, Studio City, CA (US)

(21) Appl. No.: 13/672,481

(22) Filed: Nov. 8, 2012

Related U.S. Application Data
(60) Provisional application No. 61/557,622, filed on Nov. 9, 2011.

(51) Int. Cl. G06Q 30/08

(52) U.S. Cl. CPC G06Q 30/08
USPC 705/26.3

(57) ABSTRACT

For transacting a sale, a communication module receives commitments from a plurality of buyers to buy a product offering for at least a starting price. A calculation module calculates a final price for the product offering using an algorithm. The calculation module also transacts a sale of the product offering to an original buyer of the plurality of buyers at the final price.

### CROSS-REFERENCE TO RELATED APPLICATIONS

This application claims priority to U.S. Provisional Patent Application No. 61/557,622 entitled “ONLINE ENTERTAINMENT SHOPPING METHODS WITH PLEASANT SURPRISE” and filed on Nov. 9, 2011 for Danny Wu, which is incorporated herein by reference.

### BACKGROUND

1. Field

The subject matter disclosed herein relates to sales and more particularly relates to transacting sales.

2. Description of the Related Art

Shoppers are more likely to buy when purchasing is enjoyable. Add an excitement to the purchase experience makes purchasing more enjoyable.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a transaction system;

FIG. 2 is a schematic block diagram illustrating one embodiment of a product offering database;

FIG. 3 is a schematic block diagram illustrating one embodiment of a product offering;

FIG. 4 is a schematic block diagram illustrating one embodiment of a buyer record;

FIG. 5 is a schematic block diagram illustrating one embodiment of a computer;

FIG. 6 is a schematic block diagram illustrating one embodiment of a transaction apparatus;

FIG. 7 is a schematic flow chart diagram illustrating one embodiment of a transaction method;

FIG. 8 is a schematic flow chart diagram illustrating one embodiment of an offer generation method;

FIG. 9 is a schematic flow chart diagram illustrating one embodiment of a resale method; and

FIG. 10 is a schematic flow chart diagram illustrating one embodiment of party relationships.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model.

The computer program product may be stored on a shared file system accessible from one or more servers. The computer program product may be executed via transactions that contain data and server processing requests that use Central Processor Unit (CPU) units on the accessed server. CPU units may be units of time such as minutes, seconds, hours on the central processor of the server. Additionally the accessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same computer program product via shared execution, transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the computer program product. The summed measurements of use units are periodically multiplied by unit costs and the resulting total computer program product service costs are alternatively sent to the customer and or indicated on a web site accessed by the customer which then remits payment to the service provider.

In one embodiment, the service provider requests payment directly from a customer account at a banking or financial institution. In another embodiment, if the service provider is also a customer of the customer that uses the computer program product, the payment owed to the service provider is reconciled to the payment owed by the service provider to minimize the transfer of payments.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

In one embodiment, software applications and version numbers are identified and compared to the list of software applications and version numbers that have been tested to work with the computer program product. Those software applications that are missing or that do not match the correct version will be upgraded with the correct version numbers. Program instructions that pass parameters from the computer program product to the software applications will be checked to ensure the parameter lists match the parameter lists required by the computer program product. Conversely parameters passed by the software applications to the computer program product will be checked to ensure the parameters match the parameters required by the computer program product. The client and server operating systems including the network operating systems will be identified and compared to the list of operating systems, version numbers and network software that have been tested to work with the computer program product. Those operating systems, version numbers and network software that do not match the list of tested operating systems and version numbers will be upgraded on the clients and servers to the required level.

In response to determining that the software where the computer program product is to be deployed, is at the correct version level that has been tested to work with the computer program product, the integration is completed by installing the computer program product on the clients and servers.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

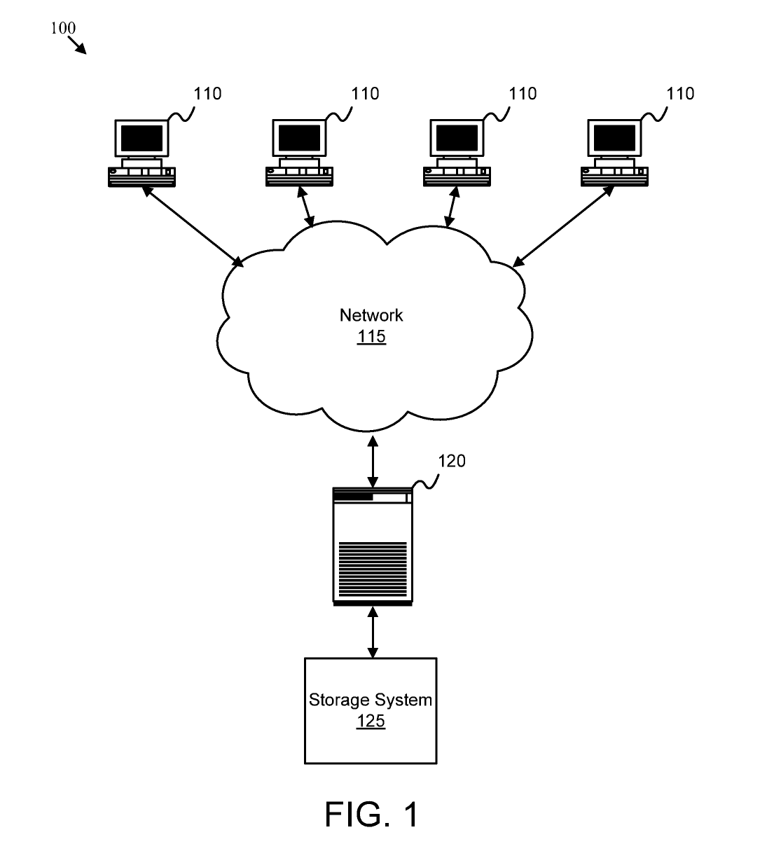

FIG. 1 is a schematic block diagram illustrating one embodiment of a transaction system 100. The system 100 includes one or more buyer workstations 110, a network 115, the server 120, and a storage subsystem 125. The network 115 maybe the Internet. Alternatively, the network 115 may be a mobile telephone network, a wide area network, a local area network, or the like.

The server 120 may transact sales as will be described hereafter. The server 120 may store data on the storage subsystem 125. One of skill in the art will recognize that the embodiments may be practiced with any number of servers 120 and or Storage Systems 125.

A buyer may transact a sale using the buyer workstation 110. The buyer workstation 110 may communicate through the network 115 with the server 120 to transact a sale. Although the buyer workstation 110 is depicted as a computer workstation, the buyer workstation 110 may also be a mobile telephone, a tablet computer, a laptop computer, a personal digital assistant, or the like. Data regarding the sale, the buyer, the seller, and/or a market maker may be stored on the Storage System 125.

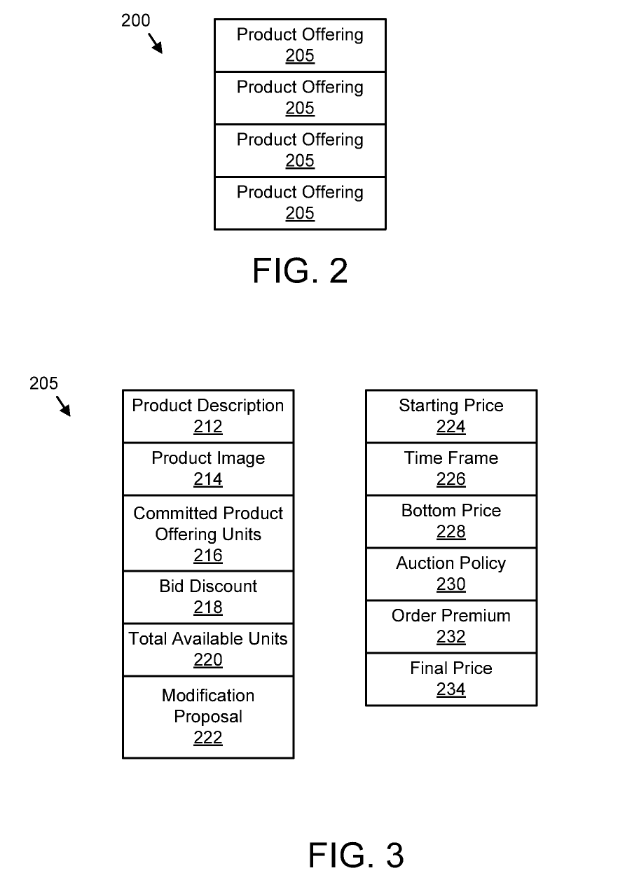

FIG. 2 is a schematic block diagram illustrating one embodiment of a product offering database 200. The product offering data base 200 may store a plurality of product offerings 205. In one embodiment, each product offering 205 is made available for purchase by the market maker. One or more sellers may communicate product offerings 205 to the product offering data base 200.

FIG. 3 is a schematic block diagram illustrating one embodiment of a product offering 205. The product offering 205 is the product offering 205 of FIG. 2. The product offering 205 includes a product description 212, a product image 214, committed product offering units 216, a bid discount 218, total available units 220, a modification proposal 222, a starting price 224, a time frame 226, a bottom price 228, an auction policy 230, an order premium 232, and a final price 234.

The product description 212 may describe the product offering 205. The product description 212 may include technical specifications, terms, warranties, fulfillment terms, and the like. The product image 214 may be an image and/or video of the product offering 205. The committed product offering units 216 may be a number of units of the product offering that are committed to for purchase by one or more buyers.

The bid discount 218 may be used to calculate one or more final prices as will be described hereafter. The total available units 220 may be a number of the product offerings 205 units that may be sold. The seller may specify the total available units 220.

The modification proposal 222 may describe allowable changes to an auction of the product offering 205. The modification proposal 222 may be implemented after the auction. The modification proposal 222 may include extending a time frame for the auction, adding a time frame for the auction, increasing total available units 220, and or shipping current orders at a current price.

The starting price 224 is a not to exceed price for the product offering 205. The starting price 224 may be communicated to the buyers, but the final price for the product offering 205 will always be less than the starting price 224.

The time frame 226 may describe a time interval during which commitments for the product offering 205 may be received. The time frame 226 may include a start time and an end time. The bottom price 228 may be the lowest price for which the product offering 205 may be sold.

The auction policy 230 may describe conditions for the auction of the product offering 205. The conditions may include what information is revealed to buyers prior the end of the time frame. The order premium 232 may be a value or algorithm for adjusting the final price for selected buyers. The final price 234 may be a single final price, an average final price, and/or an array of final prices for a plurality of buyers.

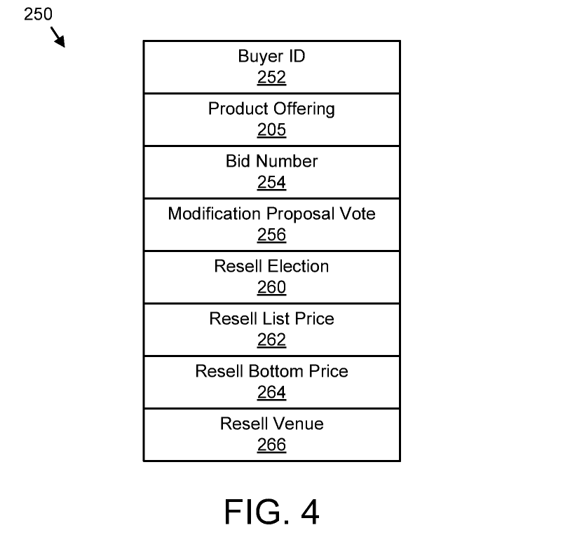

FIG. 4 is a schematic block diagram illustrating one embodiment of a buyer record 250. In one embodiment, the buyer record 250 is stored on the storage system 125. A buyer record 250 may be created and maintained for each buyer. In one embodiment, the buyer record 250 is created and maintained each time a buyer commits to a product offering 205. The buyer record 250 includes a buyer identifier 252, a product offering 205, a bit number 254, the modification proposal vote 256, a resell election 260, a resell list price 262, a resell bottom price 264, and a resell venue 266.

The buyer identifier 252 may identify the buyer. In one embodiment, the buyer identifier 252 links to buyer information including account information, credit card information, shipping addresses, email, phone, and the like.

The product offering 205 may identify the product offering 205 for which the buyer makes a commitment to purchase. The bid number 254 may be an ordinal number describing the buyers order in purchasing the product offering 205. For example, the 2nd buyer to commit to the product offering 205 may have a bit number 254 of 2.

The modification proposal vote 256 may indicate whether the buyer agrees to the modification proposal 222. For example, the modification proposal vote 256 may be a yes vote or no vote.

The resell election 260 indicates if the buyer elects to resell the product offering 205 as will be described hereafter. The resell list price 262 is the price for which the buyer will list the product offering 205 for resell. The resell bottom price 264 is the lowest price that the buyer will accept for reselling the product offering 205. The resell venue 266 may specify one or more venues for reselling the product offering 205. The venues may include but are not limited to the market maker, an auction website, classified advertisements, and the like.

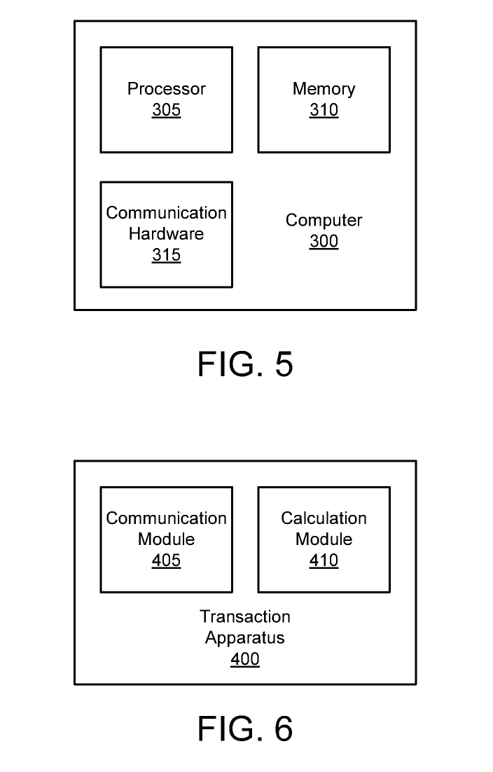

FIG. 5 is a schematic block diagram illustrating one embodiment of a computer 300. The computer 300 may be embodied in the buyer workstations 110. Alternatively, the computer 300 may be embodied in the server 120. The computer 300 includes a processor 305, a memory 310, and communication hardware 315. The memory 310 may be a computer readable storage medium such as a semiconductor storage device, a hard disk drive, a holographic storage device, a micromechanical storage device, or the like. The memory 310 may store program code. The processor 305 may execute the program code. The communication hardware 315 may communicate with other devices.

FIG. 6 is a schematic block diagram illustrating one embodiment of a transaction apparatus 400. The apparatus 400 may be embodied in the computer 300. The apparatus 400 includes a communication module 405 and the calculation module 410. The communication module 405 and the calculation module 410 may be embodied in a computer readable storage medium such as the memory 310. The computer readable storage medium may store program code that when executed by the processor 305 perform the functions of the communication module 405 and the calculation module 410.

The communication module 405 may receive commitments from a plurality of buyers to buy a product offering 205 for at least the starting price 224. The calculation module 410 may calculate a final price for the product offering 205 using an algorithm as will be described hereafter. The calculation module 410 may further transact a sale of the product offering 205 to an original buyer of the plurality of buyers at the final price.

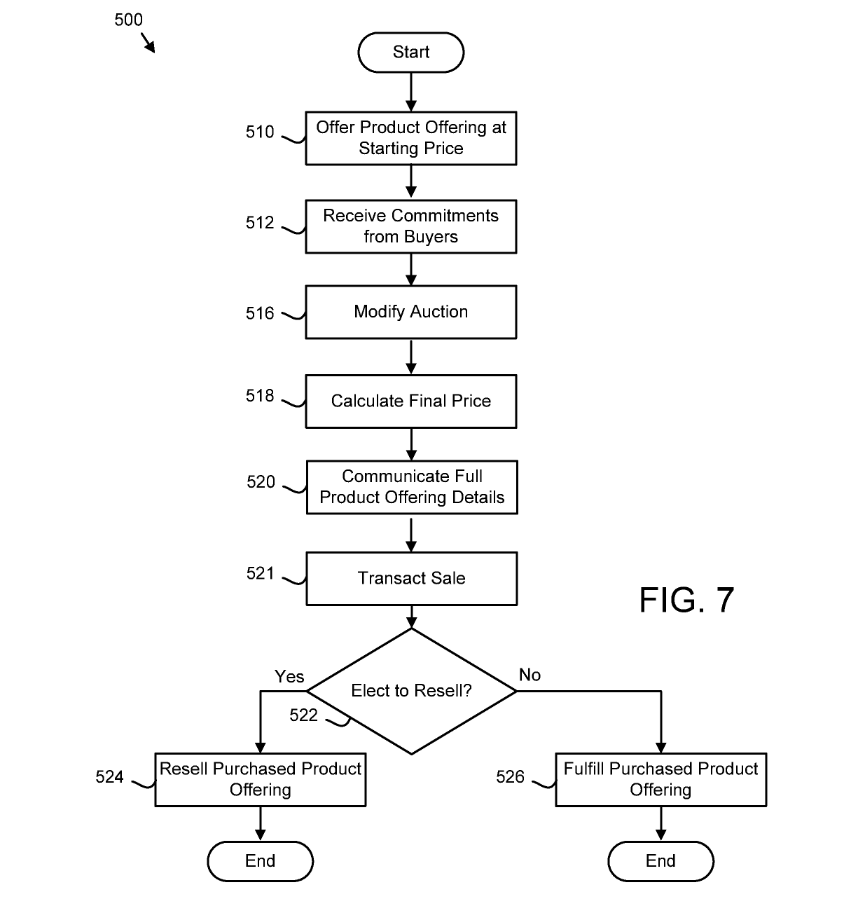

FIG. 7 is a schematic flow chart diagram illustrating one embodiment of a transaction method 500. The method 500 may perform the functions of the system 100 and the apparatus 400. The method 500 may be performed by the processor 305. Alternatively, the method may be performed by a computer readable storage medium such as the memory 310 storing program code that is executed by the processor 305 to perform the functions of the method 500.

The method 500 starts, and in one embodiment the communication module 405 may offer 510 the product offering 205 to the plurality of buyers at a starting price. In one embodiment, the server 120 offers 510 the product offering 205 through a webpage, an email, and application, or the like. The product offering 205 may be communicated through the network 115 to the buyer workstations 110.

In one embodiment, the offer of the product offering 205 includes at least one of the total available units 220, the starting price 224, the bid discount 218, the time frame 226, and the committed product offering units 216 are disclosed to the plurality of buyers prior to receiving commitments. For example, the total available units 220 and the starting price 224 may be disclosed. Alternatively, the bid discount 218 and the starting price 224 may be disclosed.

The time frame 226 may also be disclosed. Alternatively, only the start time and/or the elapsed time of the auction may be disclosed and the end time of the time frame 226 may be withheld from the buyers.

By withholding information from the buyers, the method 500 creates uncertainty and excitement with regards to the auction. Buyers know that they may purchase the product offering 205 for less than the starting price 224, but other details are withheld from the buyers. Thus the entertainment value of the auction is enhanced.

The communication module 405 receives 512 commitments from the plurality of buyers to buy the product offering 205 for at least the starting price 224. The buyer commits to the product offering 205 without knowing the final price or other information about the auction. However, the buyer does know that the final price will be less than the starting price 224.

The commitments may be received 512 from the buyer workstations 110 through the network 115 at the server 120. By using the server 122 communicate the offers 510 and receive 512 commitments, the embodiments are able to communicate with a sufficient number of buyers in a timely manner that the embodiments may be economically practiced.

The communication module 405 may receive 512 commitments from the buyers until the time frame 226 ends. The buyers may be aware of when the time frame 226 will end. Alternatively, the buyers may be unaware of when the time frame 226 will end. In one embodiment, commitments are no longer received if the final price is not to exceed the bottom price 228.

The calculation module 410 may modify 516 the auction subsequent to the end of the time frame 226. In one embodiment, the modification proposal 222 is communicated to the buyer workstations 110. In addition, the buyers may vote whether to accept the modification proposal 222. The votes may be communicated from the buyer workstations 110 through the network 115 to the server 120.

In one embodiment, the seller must agree to the modification proposal 222. The seller may agree to the modification proposal 222 and the product offering is first offered 510. Alternatively, the seller may agree to the modification proposal 222 subsequent to the offer 510.

In one embodiment, the market maker must agree to the modification proposal 222. The modification proposal 222 may include favorable terms to the buyers. In one embodiment, the auction is only modified 516 with the modification proposal 220 if a majority of the buyers agree to the modification proposal 222. In one embodiment, even if the modification proposal 222 is accepted by the majority of the buyers, some buyers may elect to opt out of the modification proposal 222 and transact the sale of the product offering 205 under the original terms of the auction.

The modification proposal 222 may include an extension of the time frame 226, the continuation of the auction for a new time frame 226, an upgrade to the product offering 205, an upgrade to the product offering 205 for an increased final price, modified delivery terms, modified credit terms, or the like. One of skill in the art will recognize that embodiments may be practiced with other modification proposals 222.

The calculation module 410 may calculate 518 a final price for product offering 205 using an algorithm. The algorithm may calculate the final price FP using Equation 1, where SP is the starting price 224, CU is the committed product offering units 216, wherein committed product offering units 216 do not exceed total available units 220, and BD is the bid discount 218. Thus the buyers help each other to obtain a better final price.

FP=SP−(CU*BD) Equation 1

In one embodiment, the final price is always lower than the starting price 224. In a certain embodiment, the unique final price is calculated for each buyer. For example, the final price for each buyer may be adjusted such that earlier buyers receive a lower price than later buyers. In one embodiment, a product equal to the order premium 232 multiplied by the bid number 254 may be added to the calculated final price to yield a final price for each buyer.

In one embodiment, the final price for each buyer is adjusted so that off-peak period buyers. For example, buyers committing to the product offering 205 between midnight and 6:00 a.m. may receive a lower final price than buyers committing between 6:00 a.m. and midnight.

The final price may be adjusted for buyers meeting specified criteria. The criteria may not be communicated to the buyers as part of the product offering 205. The specified criteria may be include but is not limited to gender, student status, birth month, birth year, postal code, zodiac sign, blood type, and the like. Alternatively, each buyer may pay the same final price.

In one embodiment, the algorithm adjusts the final price for each buyer so that the average final price is not lower than the bottom price 228. For example, a first buyer may pay a final price higher than the bottom price 228 while a second buyer may pay a final price lower than the bottom price 228, but the average of the final prices may be greater than or equal to the bottom price 228. Alternatively, the algorithm adjusts the final price for each buyer so the average final price is equal to the calculated final price. For example, the first buyer may pay a final price higher than the calculated final price and the second buyer may pay a final price lower than the calculated final price, but the average final price may be equal to the calculated final price.

In one embodiment, a buyer may pay a membership fee and become a premium buyer. A premium buyer may receive a premium service. Alternatively, a buyer that commits to a number of product offerings 205 that exceed an offering threshold becomes a frequent buyer. A frequent buyer may also receive the premium service. The premium service may include but is not limited to early access to an auction and receiving auction information that is not accessible by non-premium buyers. For example, the premium buyer and/or frequent buyer may be offered the product offering 205 two hours before non-premium buyers. Alternatively, the premium buyer and/or frequent buyer may receive a notification of when the time frame 226 ends while other buyers do not have this information.

In one embodiment, the communication module 405 may communicate 520 full product offering details to the buyers to the buyer workstations 110. The full product offering details may include the total available units 220, the starting price 224, the bid discount 218, the time frame 226, and the committed product offering units 216. In addition, the full product offering details may include the specified criteria, the algorithm, and the like. The communication module 405 may communicate 520 the full product offering subsequent to the end of the time frame 226.

The calculation module 410 may transact 521 a sale of the product offering 205 to the buyer at the final price. For example, the calculation module 410 may charge a credit card, a bank account, or the like of each buyer.

In one embodiment, each buyer may elect 522 to resell the product offering 205. The buyer may elect 522 to resell the product offering 205 through the buyer workstation 110 communicating the election through the network 115 to the server 120.

If the buyer does not elect 522 to resell the product offering 205, the calculation module 410 may fulfill 526 the buyer's purchased product offering 205 and the method 500 ends. For example, the calculation module 410 may instruct the seller to ship a physical product to the buyer, enable a download of digital content to the buyer, activate upgrade for the buyer, activate privileges for the buyer, or the like.

If the buyer elects 522 to resell the product offering 205, the calculation module 410 may resell 524 the purchased product offering 205 as will be described hereafter and the method 500 ends.

Unlike previous auctions, the method 500 provides the pleasant surprise of the lower final price, modifications to the auction that may further lower the price and/or offer other benefits, and the like after the time frame 226 for the auction is ended.

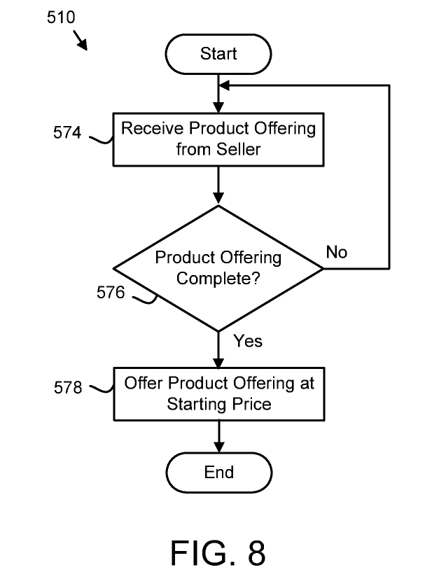

FIG. 8 is a schematic flow chart diagram illustrating one embodiment of an offer generation method 510. The offer generation method 510 may be the offer product offering at starting price step 510 of FIG. 7. The method 510 may be performed by the apparatus 400 and system 100. Alternatively, the method 510 may be performed by a computer readable storage medium storing program code.

The method 510 starts and in one embodiment, the communication module 405 for the market maker receives 574 a product offering 205 from the seller. In one embodiment, the seller creates the product offering 205 in the product offering database 200.

The market maker may determine 576 if the product offering 205 is complete. The calculation module 410 may automatically determine 576 if the product offering 205 is complete. If the product offering 205 is not complete, the seller must correct the deficiencies and re-communicate the product offering 205 to the market maker. If the product offering 205 is complete, the communication module 405 may offer 578 the product offering 205 at the starting price 224 and the method 510 ends.

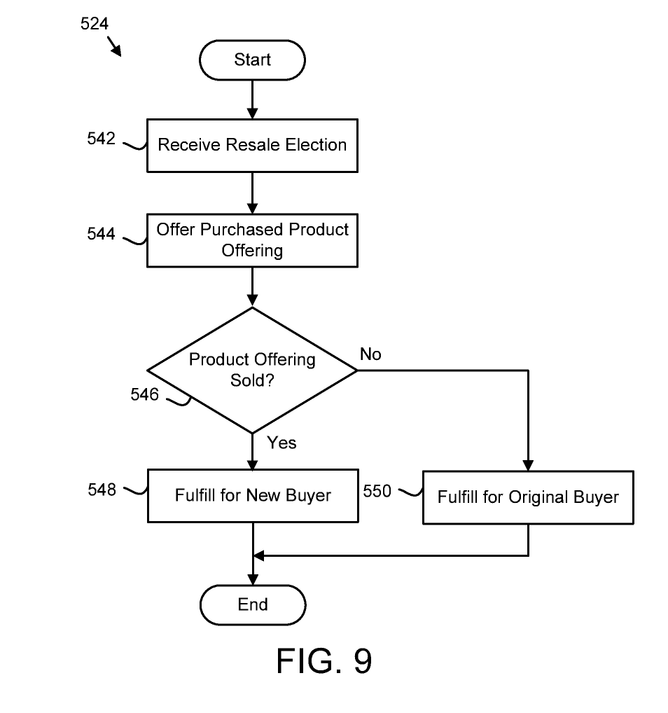

FIG. 9 is a schematic flow chart diagram illustrating one embodiment of a resale method 524. The method 524 may be the resell purchase product offering step 524 of FIG. 7. The method 524 may be performed by the apparatus 400 and the system 100. In addition, the method 524 may be performed by a computer readable storage medium storing program code executable by the processor 305.

The method 524 starts, and in one embodiment the communication module 405 receives 542 an election to resell the purchase product offering 205 for an original buyer. The communication module 405 may further receive 542 the resell list price 262, the resell bottom price 264, and the resell venue 266.

The communication module 405 may further offer 544 the purchased product offering 205. In one embodiment, the purchased product offering 205 is offered 544 through the resell venue 266. While the purchased product offering 205 is offered 544 for sale, the seller may hold the purchased product offering 205.

The calculation module 410 may determine 546 if the purchased product offering 205 is sold to a new buyer. If the purchased product offering 205 is sold, the calculation module 410 may fulfill 548 the purchased product offering 205 for the new buyer and the method 524 ends. The calculation module 410 may instruct the seller to fulfill 548 the purchased product offering 205. If the purchased product offering 205 is not sold and/or is not sold within a specified time interval, the calculation module 410 may fulfill 550 the purchase product offering 205 for the original buyer and the method 524 ends.

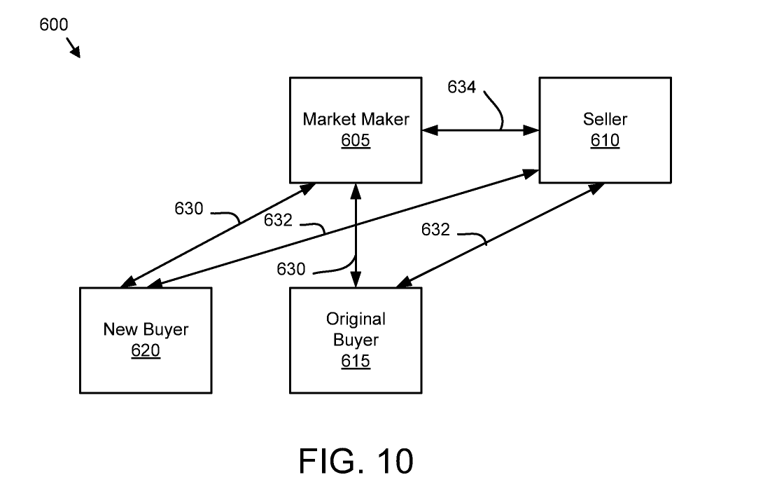

FIG. 10 is a schematic flow chart diagram illustrating one embodiment of party relationships 600. The market maker 605, the seller 610, the original buyer 615, and the new buyer 620 are shown. The market maker 605 may operate the server 120 and perform the method 500. The market maker 605 and the seller 610 may exchange 634 the product offering 205 and additional information. In addition, the market maker 605 may forward payments from transacting 521 the sale with the original buyer 615. In one embodiment, the market maker 605 retains a commission on all sales. The market maker 605 facilitates transactions and enforces rules for the auctions. The market maker 605 does not hold physical and/or virtual inventory. In addition, the market maker 605 may not fulfill the product offering 205.

In one embodiment, the seller 610 commits to sell the total available units 220 of the product offering 205 through the market maker 605. The market maker 605 may exchange 630 an offer for the product offering 205, a commitment to purchase, and the sale transaction with the original buyer 615. The seller 610 may then fulfill 632 the product offering 205 for the original buyer 615. The seller 610 may also provide service, technical support, and a warranty for the product offering 205.

If the original buyer 615 elects to resell the purchased product offering 205, the market maker 605 may exchange 630 an offer for the product offering 205, a commitment to purchase, and the sale transaction with the new buyer 620. The seller 610 may fulfill 632 the product offering 205 for the new buyer 620. In addition, the seller 610 may provide service, technical support, and a warranty for the product offering 205. Thus the original buyer 615 may purchase the product offering 205 off season and/or at a lower price and then later resell the product offering 205 for a profit.

The seller 610 commits significant merchandise for sale, sets up an initial maximum (fair and benchmarked) price as the starting price, a (negative) bid discount 218, and total available units 220. For example, the seller 610 may commits to a sale of a Blueray player model of 100 units. The starting price 224 may be $119.50 (such as Amazon benchmark price is $120) and bid discount 218 may be −$0.50. The seller 610 is fully aware of the lowest possible price, the bottom price 228.

After the market maker 605 validates the product offering 205, the market maker 605 publishes all the terms but the total available units 220. Buyers 615 therefore are unable to calculate the final price but they anticipate the final price is always more favorable than the starting price 224. This uncertainty generates excitement and entertainment value.

The seller 610 and/or market maker 605 also sets a time frame 226 based on business rules. The market maker 605 may or may not publish an auction starting time, ending time and the time span. The general rule and fair practice is that the broader the time frame 226 is the higher the volume and the lower the final price. The market maker 605 not publishing time information also increases the uncertainty.

Buyers 615 commit to the purchase without knowing the final price. The first buyer 615 bids for a nominal $119.50, the second bids for a nominal $119.00 and so on. . . The 100th customer bids for $70. Once the market maker 605 has accumulated the preset but unpublished 100 units, including a single buyer 615 buying multiple units, all buyers 615 pay the lowest price, $70 in this case. This is different from the conditional group buying method as at the sales end time, all the buyers 615 must buy at the current lowest price even there are not enough buyers 615 to purchase the whole lot, e.g. if there are only 50 buyers 615, the final price will be $95, all 50 buyers 615 must buy at $95 each. Critical mass is not an issue here and no buyer 615 is dropped by not meeting any pricing requirement of offering.

A deviation to this method is that the earliest buyer 615 gets the lowest price, e.g. the first buyer 615 pays $70 with nominal bidding price of $119.50, the second buyer 615 pays $70.50 with nominal bidding price of $119. The last buyer 615 pays $119.50 with nominal bidding price of $70. Nevertheless no buyer 615 will ever pay more than the initial maximum of $119.50. This is designed to entice buyers 615 to bid and commit purchase as early as possible once a lot of merchandise is made available for auction. The distribution of final prices is not necessarily an even arithmetic progression. The distribution model can be skewed based on any algorithm applied by the market maker 605, while buyer 615 ranking by timing is not disclosed until the auction is finished. Premium buyers 615 may be invited for an early bid. Regular buyers 615 are encouraged to constantly look for new sales.

A deviation to this method is that the seller 610 has unspecified or unlimited supply of the merchandise, the seller 610 commits to a bottom price to the market maker 605 but not published to the buyers 615. Once the price is bid down to that bottom price 228, the market maker 605 ends the auction. The seller 610 can set up recurring auctions like this with variable time frames 226. The benefit can be more frequent sales lot with lower volume and quicker fulfillment.

An alternate embodiment is that the seller 610 has published a starting price 224 and total available units 220. The seller 610 commits to a reasonable bid discount 218 to market maker 605, but the bid discount 218 is not published to buyers 615. This is more an intuitive way of advertising to attract buyers 615 by a good volume number and spurs the buyer's speculation that the bottom price 228 can be very low. The market maker 605 moderates the bid discount 218 for fair practice.

In order to hit the lowest possible price, preset time frame, either published or unpublished, can be extended by buyer votes. This “democratic” process is also a type of entertainment, e.g. 51% of the buyers 615 may vote to have the auction extended for better final price. This voting mechanism should be “pleasant” to all parties involved. Seller 610 and other buyers 615 shall be entitled to opt out, i.e. nothing shall supersede preset conditions unless it is “pleasant.”

The market maker 605 may publish all information at the end of the auction, including preset information and all fair disclosure, e.g. (partial) buyer identifies, (partial) buyer emails, (partial) IP addresses, time stamps, etc. Since not all information is available to committed buyers upfront, MM must be impartial, fair, build credibility and create customer satisfaction.

The market maker 605 forwards fulfillment information to seller 610s in batch mode. Sellers 610 are aware of all possible outcomes beforehand therefore able to manage the tolerance of lowest pricing. In general Effective Seller Price (ESP) is not negatively affected by any pricing distribution algorism applied by the MM unless under some special arrangements such as joint marketing between Seller and MM.

Before shipping, a buyer 615 has the option to list or auction the product offering 205 for resale in market maker's market place or external websites or venues, like eBay. The seller 610 then temporarily holds the shipment. The seller 610 can later ship the product offering to the new buyer 620 or to the original buyer 615 if not resold. This is designed for the buyers 615 to resell the merchandise since the committed purchases are not refundable. Buyers 615 shall be aware of this term as this platform is not a full service retail store with refund privilege. This resale channel also entices arbitragers to commit to (early) purchase to clear the sellers' inventory and increase buyer base or simply for all buyers 615 to get a better deal. Buyers 615 can resell the product offering 205 for a profit without touching physical product and avoid two way shipping. This generates additional commission to market maker 605 and provides new buyers 615 with additional quality assurance to new buyers 620 as a private sale is fulfilled by a professional merchandiser.

The market maker 605 facilitates and regulates all transactions and ensures all parties playing fair. Market maker 605 may provide insurance, protection and other value added services to both buyers 615 and sellers 620, including buyer feedback and ratings for sellers. Market maker previously published information on completed auctions will provide buyers 615 with intelligence for future purchases.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for transacting a sale comprising
receiving, by use of a processor, commitments from a plurality of buyers to buy a product offering for at least a starting price;
calculating a final price for the product offering using an algorithm; and
transacting a sale of the product offering to an original buyer of the plurality of buyers at the final price.

2. The method of claim 1, wherein at least one of the total available units, the starting prices the bid discount, a time frame, and committed product offering units are disclosed to the plurality of buyers prior to receiving commitments.

3. The method of claim 2, wherein the total available units and the starting price are disclosed to the plurality of buyers prior to receiving commitments.

4. The method of claim 2, wherein the bid discount and the starting price are disclosed to the plurality of buyers prior to receiving commitments.

5. The method of claim 2, wherein the time frame is disclosed to the plurality of buyers prior to receiving commitments.

6. The method of claim 1, wherein the algorithm calculates the final price FP as FP=SP−(CU*BD), where SP is the starting price, CU is committed product offering units wherein the committed product offering units do not exceed total available units, and BD is a bid discount.

7. The method of claim 1, wherein the final price is lower than the starting price.

8. The method of claim 1, wherein each buyer pays a unique final price.

9. The method of claim 1, wherein each buyer pays the same final price.

10. The method of claim 1, wherein the final price for the original buyer is adjusted such that earlier buyers receive a lower price than later buyers.

11. The method of claim 1, wherein the final price for the original buyer is adjusted such that off-peak period buyers receive a lower price than peak period buyers.

12. The method of claim 1, wherein the final price for the original buyer is adjusted such buyers meeting specified criteria receive a lower price than buyers not meeting the specified criteria.

13. The method of claim 4, the specified criteria selected from the group consisting of gender, student status, birth month, birth year, and postal code. The calculation module 410

14. The method of claim 1, wherein premium buyers of the plurality of buyers receive a premium service in response to paying a membership fee and frequent buyers for the plurality of buyers receive the premium service, wherein the premium service is at least one of early access to an auction and receiving auction information that is not accessible by non-premium buyers and non-frequent buyers.

15. The method of claim 1, wherein commitments are no longer received if the final price does not exceed a bottom price.

16. The method of claim 1 wherein commitments are only received during a time frame and the time frame is not disclosed to the plurality of buyers prior to receiving commitments.

17. The method of claim 1, further comprising:
communicating a modification proposal to the plurality of buyers subsequent to expiration of a time frame, wherein the modification proposal is selected from the group consisting of extending a time frame, increasing total available units, and shipping current orders at a current price;
receiving votes on the modification proposal from the plurality of buyers; and
modifying the auction policy in response to the votes.

18. The method of claim 1, further comprising:
receiving an election to resell from the original buyer; and
offering the original buyer's purchased product offering for sale.

19. The method of claim 18, wherein the seller holds and fulfills the purchased product offering.

20. A computer program product for transacting a sale, the computer program product comprising a computer readable storage medium having program code embodied therein, the program code readable/executable by a processor to:
receive commitments from a plurality of buyers to buy a product offering for at least a starting price;
calculate a final price for the product offering using an algorithm; and
transact a sale of the product offering to an original buyer of the plurality of buyers at the final price.
